(19) United States
(12) Patent Application Publication
(10) Pub. No.: US 2003/0030770 A1
(43) Pub. Date: Feb. 13, 2003

(54) Eyewear assembly including auxiliary eyeglasses

(76) Inventor: Scott K. Strenk, Chandler, AZ (US)

Correspondence Address: Sullivan Law Group, Suite 120, 5060 North 40th Street, Phoenix, AZ, 85018-2140, US

(21) Appl. No.: 09/927,176

(22) Filed: Aug. 10, 2001

(51) Int. Cl. G02C 9/00; G02C 7/08

(52) U.S. Cl. 351/57

(57) ABSTRACT

The eyewear assembly includes primary and auxiliary eyeglasses that are attachable to each other by catch-and-click mating engagement and are detachable from each other. The primary eyeglasses include a frame, lenses, and temples. The frame has lens rims on which the lenses are mounted, a bridge connecting the lens rims, and temple mounts. The frame also has first and second recessed sockets each provided with respective metallic, non-magnetized bottom and side walls. The side walls are oriented substantially vertical when the primary eyeglasses are worn on the human face. The auxiliary eyeglasses include an auxiliary frame having first and second arms, each of which has a respective magnet permanently affixed thereto. The magnets fit into corresponding sockets and magnetically attract the metallic, non-magnetized bottom and side walls of the sockets to permit catch-and-click mating engagement of the magnets with the sockets.

### BACKGROUND OF THE INVENTION

1. Field of the Invention

This invention relates to eyewear, and in particular this invention relates to mechanisms for attaching auxiliary eyeglasses, especially those having tinted lenses, to primary eyeglasses by magnetic attraction.

2. Description of the Related Art

For years, prescription eyewear has been used for correcting such conditions as near-sightedness and farsightedness. Generally, the lenses of prescriptive eyewear are ground to improve the visual acuity of the wearer. Non-prescription eyewear is also sometimes worn by individuals wishing to have the aesthetic appearance of eyeglasses, but who do not require prescription lenses for vision correction purposes.

Prescription and non-prescription lenses may be tinted to protect and shade the eyes during outdoor use, such as to facilitate driving, physical exercise, sports, and other outdoor activities. However, tinted lenses are commonly unwanted for indoor use in which the light is usually dimmer compared to the outdoors. For this reason, it is not uncommon for people to utilize two sets of eyeglasses: a non-tinted pair for indoor use and a tinted pair for outdoor use. But carrying two or more pairs of eyeglasses is inconvenient and costly. Also, by carrying twice as many pairs of eyeglasses, the likelihood that one of the pairs will be misplaced is increased. Additionally, larger expense is usually incurred in updating prescription lenses for two sets of eyeglasses instead of one.

Auxiliary (or supplemental) eyewear has been used in conjunction with prescription and non-prescription eyewear to overcome the drawbacks of owning, carrying, and maintaining two pairs of eyeglasses. Typically, auxiliary eyewear includes a pair of tinted lenses that may be placed over prescription lenses of primary eyeglasses during outdoor use or in other bright light environments. Auxiliary eyewear may also be used to modify the power of the prescription lenses of the primary eyeglasses, such as for reading. However, auxiliary eyeglasses most commonly have tinted, non-prescriptive lenses, and, therefore, are not as expensive to replace when lost and do not require constant updating in prescriptive strength.

The art is replete with different clip-on designs for attaching auxiliary eyeglasses to conventional eyeglasses. For example, U.S. Pat. No. 5,696,571 discloses clip-on sunglasses with a bridge mount that fits behind the bridge of the eyeglasses on which the sunglasses are mounted, and mounting clips on the bottom of each eyewire. U.S. Pat. No. 5,867,244 discloses auxiliary clip-on eyeglasses having first and second outboard clips that fit around a conventional eyeglass frame circumjacent the temple blocks, and a third clip that fits beneath and engages the bridge.

More recently, magnetic means have been used to secure auxiliary eyewear to conventional eyeglasses. For example, U.S. Pat. No. 5,980,036 discloses eyeglass devices in which the primary frame has a front face and sides carrying magnets. The auxiliary eyeglass frame includes metal members that are attracted to and engage the magnets of the primary frame. As pointed out in U.S. Pat. No. 6,139,142, a problem with this type of vertical magnet arrangement is that strenuous activity such as jogging or exercising can create downward shearing forces that cause the auxiliary eyeglasses to slide off and detach from the conventional eyeglass frames.

Other designs involve the use of magnet-to-magnet attraction, with a first pair of magnets being carried by the conventional eyeglass frames and a second pair of magnets being carried by the auxiliary eyeglass frames. For example, U.S. Pat. No. 6,139,142 and WO 01/51982 disclose magnet-to-magnet arrangements in which a pair of magnets of an auxiliary eyeglass frame are received beneath a pair of magnets of a conventional eyeglass frame.

There are several drawbacks to the use of magnet-to-magnet designs. Magnets are usually attached to primary and auxiliary eyeglass frames either with adhesive or by clamping or sealing mechanisms. These attachment means are prone to failure, causing the magnets to dislodge from the frames, especially during strenuous activities such as exercise. The greater the number of magnets used in the eyewear, the higher the probability of failure. Further, magnets are relatively heavy compared to other plastic and metal materials used in eyeglass frames. The additional weight inherent to magnets can become appreciable to the wearer, especially across the bridge of the wearer's nose. Moreover, magnet-to-magnet designs such as disclosed in WO 01/51982 have a surface-to-surface attraction. The opposing magnets of the conventional and auxiliary eyeglasses must be relatively closely aligned before a raised magnet of the auxiliary frame will be attracted to the magnet-containing socket recess of the conventional eyeglass frame.

### OBJECTS OF THE INVENTION

Accordingly, it is one object of this invention to develop an eyewear assembly that reduces the number of magnets compared to conventional magnet-to-magnet assemblies, thereby diminishing the likelihood of magnet dislodgment during strenuous activities.

Another object of this invention is to develop an eyewear assembly that is provided with a lighter weight than conventional magnet-to-magnet designs by reducing the number of magnets in the assembly.

Still another object of the invention to simplify the task of connecting auxiliary eyeglasses to primary eyeglasses, even when the primary eyeglasses are on the face of its wearer, by providing a larger “target” area for the magnetic attraction compared to conventional eyewear having magnet-to-magnet attachment designs.

Additional objects and advantages of the invention will be set forth in the description that follows, and in part will be apparent from the description, or may be learned by practice of the invention. The instrumentalities and combinations pointed out in the appended claims may be used to realize and obtain one or more of these and objects and advantages of the invention.

### SUMMARY OF THE INVENTION

To achieve the foregoing objects, and in accordance with the purposes of the invention as embodied and broadly described in this document, according to a first aspect of this invention there is provided an eyewear assembly sized and configured for wearing on a human face. The eyewear assembly comprises primary eyeglasses and auxiliary eyeglasses that are attachable by catch-and-click mating engagement and are detachable from each other. The primary eyeglasses comprise a frame comprising a bridge, first and second lens rims connected by the bridge, and first and second temple mounts on opposite sides of the frame and attached to the first and second lens rims, respectively. The frame includes first and second recessed sockets each provided with respective metallic, non-magnetized bottom and side walls, the side walls being oriented substantially vertical when the primary eyeglasses are worn on the human face. The primary eyeglasses further comprise first and second temples mounted to the first and second temple mounts, respectively, and first and second lenses mounted to the first and second lens rims, respectively. The auxiliary eyeglasses comprise an auxiliary frame, the auxiliary frame comprising an auxiliary bridge, first and second auxiliary lens rims connected by the auxiliary bridge, and first and second arms each having a respective magnet permanently affixed thereto. Each of the magnets has a respective protruding portion sized and configured to fit into a corresponding one of the sockets and to magnetically attract the metallic, non-magnetized bottom and side walls of the sockets to permit catch-and-click mating engagement of the magnets with the sockets. The auxiliary eyeglasses also include first and second auxiliary lenses mounted to the first and second auxiliary lens rims, respectively.

A second aspect of the invention is also provided to achieve the foregoing objects. In accordance with the purposes of the invention as embodied and broadly described in this document, the second aspect of the invention provides an eyewear assembly sized and configured for wearing on a human face. The primary eyeglasses comprise a frame comprising a bridge, first and second lens rims connected by the bridge, and first and second temple mounts on opposite ends of the frame and attached to the first and second lens rims, respectively. The primary eyeglasses further comprise first and second temples mounted to the first and second temple mounts, respectively, and first and second lenses mounted to the first and second lens rims, respectively. First and second magnets are permanently affixed to the frame, preferably to the temple mounts. The auxiliary eyeglasses comprise an auxiliary frame, which comprises an auxiliary bridge, first and second auxiliary lens rims connected by the auxiliary bridge, and first and second arms each having a respective recessed socket. The auxiliary eyeglasses further comprise auxiliary lenses mounted on the auxiliary lens rims. Each of the sockets is provided with respective metallic, non-magnetized bottom and side walls. The side walls are oriented substantially vertical when the primary eyeglasses are worn on the human face and attached to the auxiliary eyeglasses. The magnets of the primary eyeglasses have protruding portions sized and configured to fit into corresponding ones of the sockets of the auxiliary eyeglass frame and to magnetically attract the metallic, non-magnetized bottom and side walls of the sockets to permit catch-and-click mating engagement of the magnets with the sockets.

One of the distinct advantages of the first and second aspects of this invention is the catch-and-click mating engagement feature. The magnets permanently affixed to either the primary or auxiliary eyeglass frames attract not only to the metallic bottom surface of their corresponding sockets, but also the metallic side walls of the sockets. As a consequence, a relatively large surface area is provided at which the magnets may engage or “catch” the upper edges of the corresponding metallic socket side walls. Once caught on the metallic side walls, the magnets may be translated in small lateral adjustments while maintaining contact against the side wall edges until the magnets are received into the sockets. The reception of the magnets into their corresponding sockets provides a clicking engagement, which clearly indicates to the wearer that the auxiliary eyeglasses are fully engaged and mated with the primary eyeglasses.

In accordance with one variation of the first aspect described above, the first and second temple mounts each has a respective lobe that defines one of the sockets. In a variation of the second aspect, the first and second temple mounts each has a respective lobe in which a respective one of the magnets is embedded and permanently affixed.

In accordance with another variation of the first and second aspects of the invention, the metallic, non-magnetized bottom and side walls of the socket have a cup shape. The metallic, non-magnetized side walls preferably have a substantially identical cross section to protruding portions of the magnets to allow snug fitting of the protruding portions in the sockets. The side walls of the sockets preferable have a circular cross section, and the magnets are preferably cylindrical. It is preferred that, when the primary eyeglasses are worn on the human face, the sockets each have a respective opening facing downward for receiving a corresponding one of the magnets from below.

These and other objects, aspects and advantages of the invention will be apparent to those skilled in the art upon reading the specification and appended claims, which when read in conjunction with the detailed drawings, explain the principles of this invention.

### BRIEF DESCRIPTION OF THE DRAWINGS

The accompanying drawings are incorporated in and constitute a part of the specification. The drawings, together with the general description given above and the detailed description of the preferred embodiments and methods given below, serve to explain the principles of the invention. In such drawings:

FIG. 1 is an isometric view of an eyewear assembly, taken from below the eyewear assembly, embodying certain aspects of the present invention, the eyewear assembly illustrated with primary eyeglasses mated with auxiliary eyeglasses;

FIG. 2 is a front exploded elevational view of the eyewear assembly of FIG. 1, showing the primary and auxiliary eyeglasses out of mating engagement;

FIG. 3A and FIG. 3B are top plan views of the eyewear assembly of FIG. 1, in which FIG. 3A depicts the primary and auxiliary eyeglasses in mating engagement and in which FIG. 3B is an exploded view depicting the primary and auxiliary eyeglasses out of mating engagement;

FIG. 4 is a side sectional view of the eyewear of FIG. 1 taken along sectional line IV-IV of FIG. 3A;

FIG. 5 is a front, enlarged exploded elevational view of an eyewear assembly according to another embodiment of the invention.

### DETAILED DESCRIPTION OF PREFERRED EMBODIMENTS AND METHODS OF THE INVENTION

Reference will now be made in detail to the presently preferred embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the preferred embodiments and methods. The invention according to its various aspects is particularly pointed out and distinctly claimed in the attached claims read in view of this specification, and appropriate equivalents.

It is to be noted that, as used in the specification and the appended claims, the singular forms “a,” “an,” and “the” include plural referents unless the context clearly dictates otherwise.

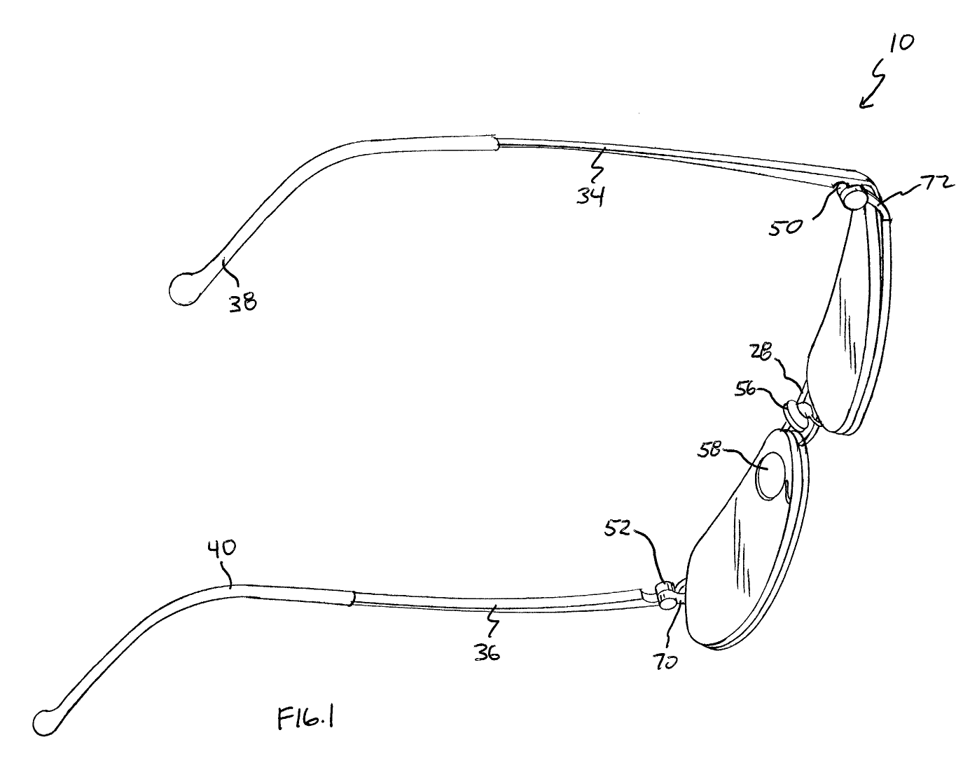

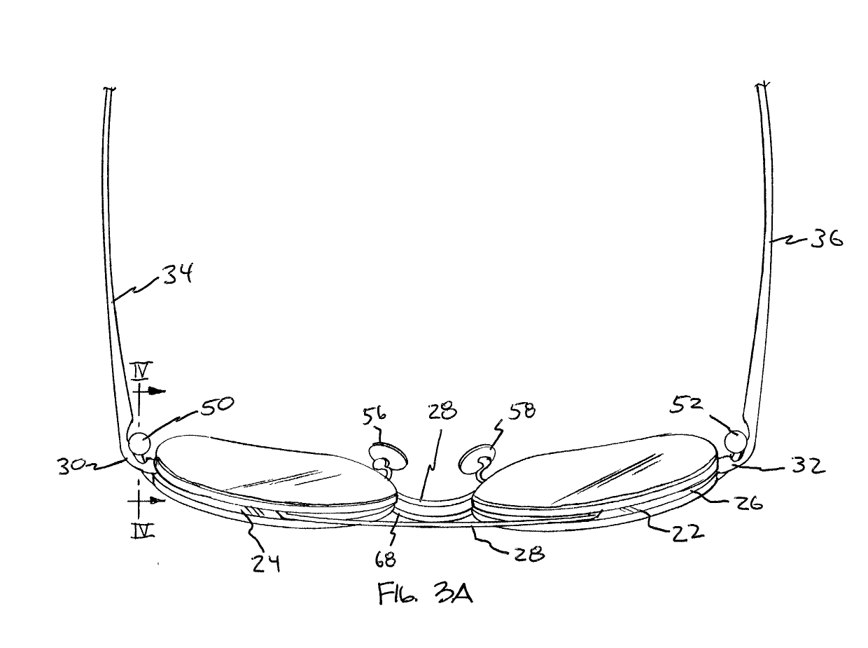

Referring now more particularly to the drawings, and in particular to FIGS. 1, 2, 3A, 3B, and 4, there is an eyewear assembly generally designated by reference numeral 10 in FIG. 1. The assembly 10 comprises primary eyeglasses 20 and auxiliary eyeglasses 60.

The primary eyeglasses 20 include a frame 22 having a first lens rim 24 and a second lens rim 26. As used herein for the purpose of describing the drawings, “first” generally refers to the right side of the illustrated eyewear 10 and “second” generally refers to the left side of the illustrated eyewear 10. The terms left and right refer to the orientation of the eyewear 10 relative to the left and right eyes of the wearer of the eyewear 10. As illustrated, the lens rims 24 and 26 may have the appearance of a wire. It is to be understood, however, that the invention covers lens rims of various materials, sizes, and shapes, including those that surround only a portion of the lenses mounted thereon. A bridge 28 is interposed between and connects the lens rims 24 and 26 to each other. It is common for the lens rims 24 and 26 and the bridge 28 to be of a unitary construction, although these components may be welded or otherwise interconnected together.

A first temple mount 30 and a second temple mount 32 are located on opposite sides of the frame 22 and are attached to temporal portions of the first and second lens rims 24 and 26, respectively. The temple mounts 30 and 32 are generally positioned laterally outward to the first and second lens rims 24 and 26, and extend rearwardly. The temple mounts 30 and 32 may be formed integrally with or attached to the lens rims 24 and 26. A first temple 34 and a second temple 36 are mounted to the first and second temple mounts 30 and 32. The first and second temples 34 and 36 may be integrally formed as a unitary piece with the temple mounts 30 and 32, although it is preferred to use pivot or hinge joints to connect the first and second temples 34 and 36 to the first and second temple mounts 30 and 32, respectively. The temples 34 and 36 include adaptive earpieces 38 and 40 at their rearmost portions. The earpieces 38 and 40 may be made of rubber. As seen in the drawings, the left and right sides of the primary eyeglasses 20 are substantially symmetrical.

Mounted on the lens rims 26 and 28 are first lens 42 and second lens 44. Usually, the lenses 42 and 44 are prescription lenses, although the lenses 42 and 44 may be non-prescriptive. The lenses 42 and 44 may be optically clear (non-tinted) or tinted. Also mounted on the lens rims 26 and 28 are nose rests 56 and 58. The nose rests 56 and 58 sit on the wearer's nose to support the eyeglasses 20. The nose rests 56 and 58 are optional, however, and may be removed so permit the bridge 28 of the primary eyeglass frame 22 to rest on the wearer's nose.

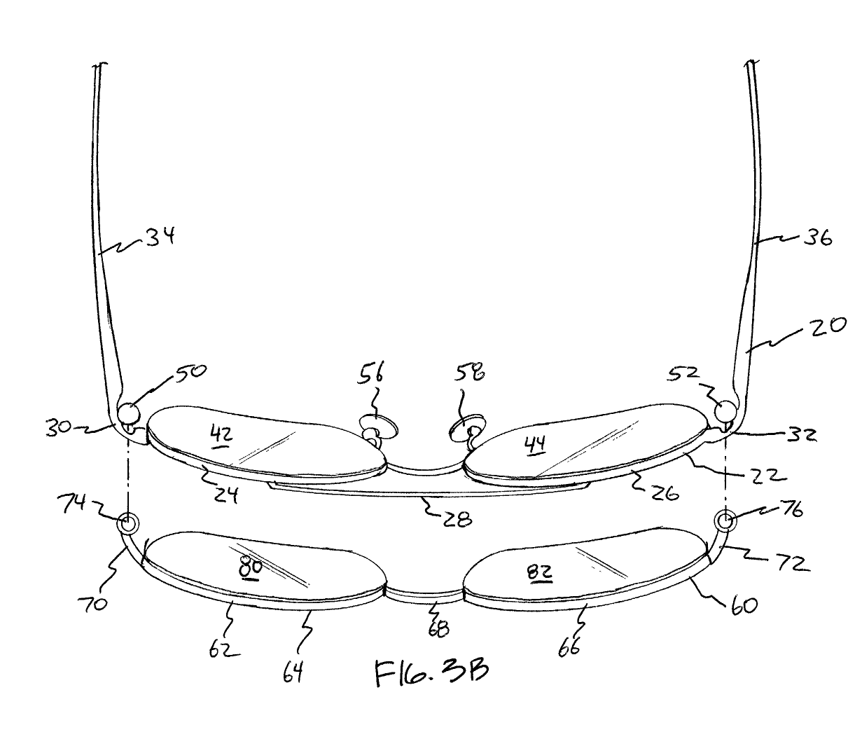

The frame 22 also includes a first lobe 50 connected to the first temple mount 30 and a second lobe 52 connected to the second temple mount 32. The lobes 50 and 52 may be integrally formed as a unitary piece with the primary frame 22, or may be connected to the temple mounts 30 and 32 by conventional means. The lobes 50 and 52 contain recessed sockets (unnumbered, and also referred to herein as lobe sockets) provided with respective bottom walls and side walls and having an open end facing downward to expose the bottom wall. Each of the bottom and side walls is preferably made of a metallic, non-magnetized material having an affinity or attraction to magnets. By “non-magnetized,” it is meant that a sufficient external magnetic field has not been applied to the metallic material to make it into a permanent magnet that exerts an appreciable magnetic force that contradicts the objects of this invention. The entire lobes 50 and 52 may be made of the metallic, non-magnetized material, or the lobes 50 and 52 may include an inner lining comprising the metallic, non-magnetized material. In a preferred embodiment illustrated in FIG. 4, the side walls are oriented substantially vertically when the primary eyeglasses 10 are worn on the face of its wearer. Preferably, the bottom and side walls are made of a paramagnetic materials, which as referred to herein are materials attracted to magnets, but that do not become permanently magnetized. More preferably, the bottom and side walls comprise, and still more preferably consist of, stainless steel. In a less preferred embodiment, a ferromagnetic material (such iron, cobalt, or nickel) that has not been permanently magnetized may be used.

The auxiliary eyeglasses 60 comprise an auxiliary frame 62, which includes a first auxiliary lens rim 64 and a second auxiliary lens rim 66, and an auxiliary bridge 68 interconnecting the auxiliary lens rims 64 and 66. In a preferred embodiment, the auxiliary eyeglass frame 62 is substantially identical in size and shape as compared to the primary frame 22. Thus, mating of the frames 22 and 62 presents a uniform matching profile all along the outer perimeter as viewed from a front elevation. For example, the bridge 28 of the primary eyeglasses 20 is preferably juxtaposed with the auxiliary bridge 68.

Mounted on the auxiliary lens rims 64 and 66 are first and second auxiliary lenses 80 and 82, respectively. Preferably, the first and second auxiliary lenses 80 and 82 overlay the first and second lenses 42 and 44, respectively. The auxiliary lenses 80 and 82 are preferably tinted to shield the wearer's eyes from sunlight. In this manner, the auxiliary eyeglasses 60 may be used as sun shades for prescription primary eyeglasses 20.

First and second arms 70 and 72 extend from the first auxiliary lens rim 54 and the second auxiliary lens rim 66, respectively, in a lateral and rearward direction, preferably along an arcuate path. The arms 70 and 72 may be integrally formed as part a unitary part of the auxiliary frame 60, or may be incorporated into the auxiliary frame 60 by welding, screws, or other attachment means. In the illustrated embodiment, the arms 70 and 72 are provided with respective sockets (unnumbered). Magnets 74 and 76 are received in and permanently affixed to the sockets of the arms 70 and 72, respectively. By permanent, it is meant that the magnets 74 and 76 are intended to remain affixed to the arms 70 and 72 when the auxiliary eyeglasses 60 are unmated from the primary eyeglasses 20. By way of example, adhesive, tight sealing engagements, or the like may be used to permanently affix the magnets 74 and 76 to the arms 70 and 72. As shown in FIG. 4, each of the magnets 74 and 76 has a respective embedded portion received in the socket, although in a less preferred embodiment the sockets may be eliminated and the magnets 74 and 76 may be affixed to the surfaces of the arms 70 and 72. Each of the magnets 74 and 76 also has a respective protruding portion that extends beyond the socket. The protruding portions of the magnets 74 and 76 are sized and configured to fit into corresponding ones of the sockets of the lobes 50 and 52. In a preferred embodiment, the protruding portions of the magnets 74 and 76 are cylindrical in shape, and the recessed sockets of the lobes 50 and 52 are also cylindrical. It should be understood, however, that the protruding portions of the magnets 74 and 76 and the recessed sockets of the lobes 50 and 52 may undertake other shapes, such as those having polygonal cross sections.

When the protruding portions of the magnets 74 and 76 are received in the sockets of lobes 50 and 52, respectively, the metallic, non-magnetized bottom and side walls of the sockets are sufficiently attracted to the magnets 74 and 76 to retain the auxiliary eyeglasses 60 on the primary eyeglasses 20 without requiring additional support. The magnetic attractive forces of the magnets 74 and 76 prevent the auxiliary eyeglasses 60 from being unintentionally disengaged from the primary eyeglasses 20, even during strenuous activities. Moreover, reception of the protruding portions of the magnets 74 and 76 into the socket recesses impedes the likelihood that shearing forces will dislodge the magnets from their metallic mating surfaces.

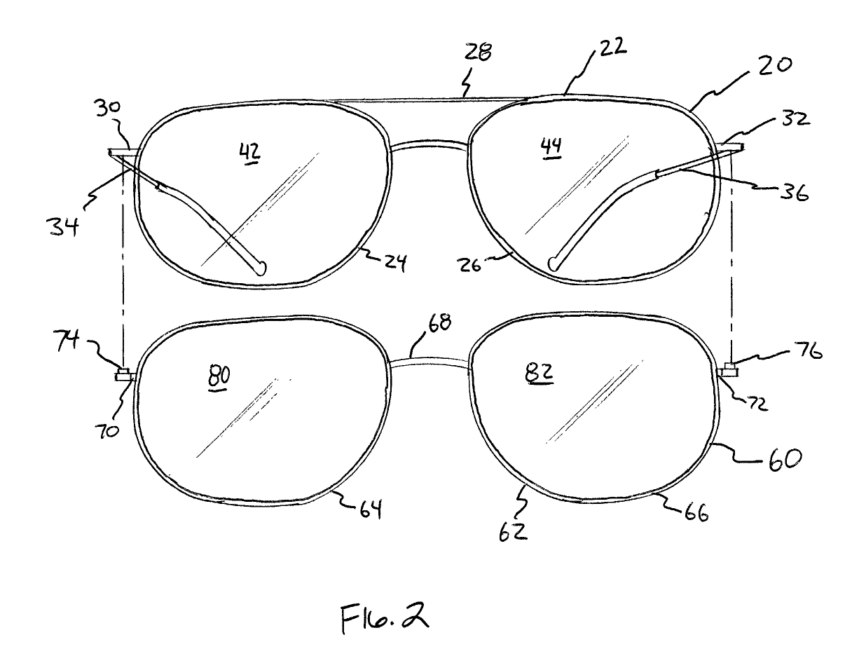

Referring to FIG. 2, the auxiliary eyeglasses 60 may be mated with the primary eyeglasses 20, either while the primary eyeglasses 20 are being worn on the wearer's face or while the primary eyeglasses 20 are in the hands of the wearer, as follows. The auxiliary eyeglasses 60 are placed in front of and slightly below the primary eyeglasses 20, with the bridge 28 being aligned laterally with the auxiliary bridge 68. The auxiliary eyeglasses 60 are then raised relative to the primary eyeglasses 20 until the magnets 74 and 76 catch via magnetic attraction the metallic, non-magnetized socket side walls of lobes 50 and 52. The entire lower surfaces of the magnets 74 and 76 are attracted to the exposed edges of the socket side walls. Thus, the lower surfaces of the magnets 74 and 76 do not have to be perfectly aligned with the bottoms walls of the lobe sockets before the magnets attract and mate with exposed edges of the side walls of the lobe sockets. Thus, the lobe socket side walls provide a larger “target” for the magnets 74 and 76 in comparison to the bottom surface of lobe sockets. Once the magnets 74 and 76 have been brought into contact with the edges of the side walls of the lobe sockets, slight adjustment of the arms 70 and 72 of the auxiliary eyeglasses 60 causes the magnets 74 and 76 to enter into the lobe sockets. In a preferred embodiment entry of the magnets 74 and 76 into the lobe sockets generates a distinct clicking sound, thereby notifying the wearer that the auxiliary eyeglasses 60 are completely mated with the primary eyeglasses 20.

Separation of the primary eyeglasses from the auxiliary eyeglasses 60 may be achieved by applying a downward force to one side of the auxiliary eyeglass frame 62 to disengage the magnet 74 or 76 on that side of the frame 62 from its corresponding lobe socket. The other magnet 74 or 76 is then easily removed from its corresponding lobe socket.

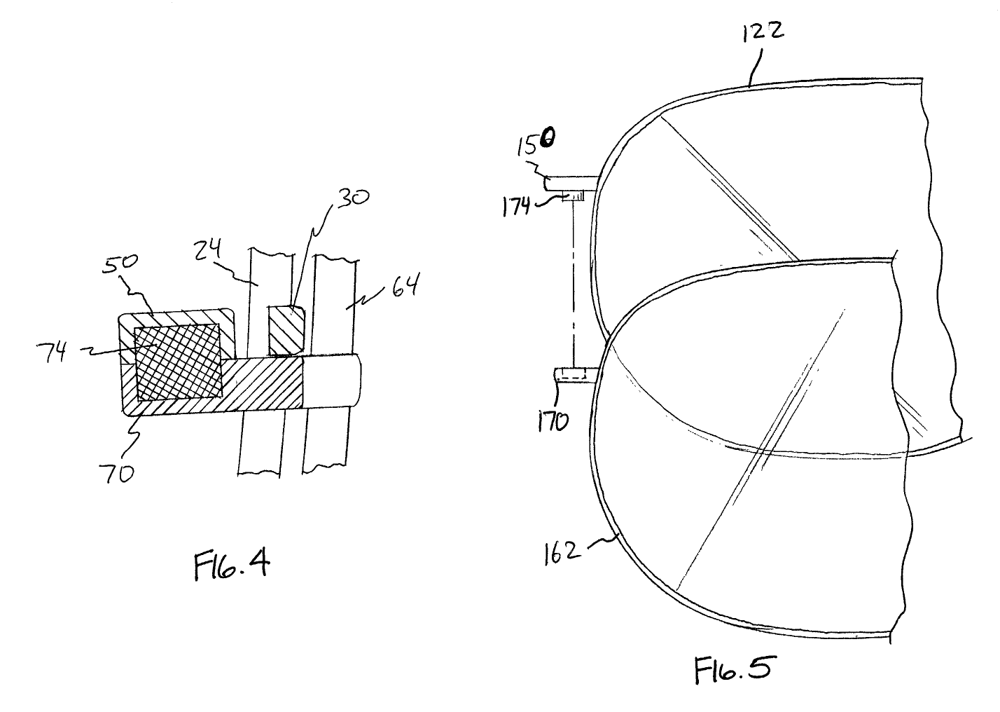

Additional advantages and modifications will readily occur to those skilled in the art. For example, it is to be understood that the use of clips and other additional supports is within the scope of this invention. Another modification is shown in FIG. 5, in which the magnets 174 are permanently affixed to the primary eyeglass frames 122. More particularly, the magnets 174 each have an embedded portion permanently secured in the lobes 150 of the primary eyeglass frames 122 and a protruding portion that is temporarily received in recessed sockets of arms 170 of the auxiliary eyeglass frames 162.

The foregoing detailed description of the preferred embodiments of the invention has been provided for the purpose of explaining the principles of the invention and its practical application, thereby enabling others skilled in the art to understand the invention for various embodiments and with various modifications as are suited to the particular use contemplated. The foregoing detailed description is not intended to be exhaustive or to limit the invention to the precise embodiments disclosed. Modifications and equivalents will be apparent to practitioners skilled in this art and are encompassed within the spirit and scope of the appended claims.

What is claimed is:

1. An eyewear assembly sized and configured for wearing on a human face and comprising primary eyeglasses and auxiliary eyeglasses that are attachable by catch-and-click mating engagement and detachable from each other,
the primary eyeglasses comprising:
a frame comprising a bridge, first and second lens rims connected by the bridge, and first and second temple mounts on opposite sides of the frame and attached to the first and second lens rims, respectively, the frame including first and second recessed sockets each provided with respective metallic, non-magnetized bottom and side walls, the side walls being oriented substantially vertical when the primary eyeglasses are worn on the human face;
first and second temples mounted to the first and second temple mounts, respectively; and
first and second lenses mounted to the first and second lens rims; and
the auxiliary eyeglasses comprising:
an auxiliary frame comprising an auxiliary bridge, first and second auxiliary lens rims connected by the auxiliary bridge, and first and second arms connected to the first and second auxiliary lens rims, respectively, the first and second arms each having a respective magnet permanently affixed thereto, the magnets having protruding portions sized and configured to be received into corresponding ones of the sockets and to magnetically attract the metallic, non-magnetized bottom and side walls of the sockets to permit catch-and-click mating engagement of the magnets with the sockets; and
first and second auxiliary lenses mounted to the first and second auxiliary lens rims, respectively.

2. The eyewear assembly of claim 1, wherein the first and second lateral temple mounts have respective lobes containing the first and second sockets, respectively.

3. The eyewear assembly of claim 1, further comprising first and second earpieces covering distal portions of the first and second temples, respectively.

4. The eyewear assembly of claim 1, wherein the metallic, non-magnetized bottom and side walls define a cup.

5. The eyewear assembly of claim 1, wherein the metallic, non-magnetized side walls have a circular cross section.

6. The eyewear assembly of claim 1, wherein the metallic, non-magnetized bottom and side walls are paramagnetic.

7. The eyewear assembly of claim 1, wherein the metallic, non-magnetized bottom and side walls comprise stainless steel.

8. The eyewear assembly of claim 1, wherein the first and second temples are pivotally connected to the first and second lateral temple mounts.

9. The eyewear assembly of claim 1, wherein when the primary eyeglasses are worn on the human face, the sockets each have a respective opening facing downward for receiving a corresponding one of the magnets from below.

10. An eyewear assembly sized and configured for wearing on a human face and comprising primary eyeglasses and auxiliary eyeglasses that are attachable by catch-and-click mating engagement and detachable from each other,
the primary eyeglasses comprising:
a frame comprising a bridge, first and second lens rims connected by the bridge, and first and second temple mounts on opposite sides of the frame and attached to the first and second lens rims, respectively;
first and second temples mounted to the first and second temple mounts, respectively;
first and second lenses mounted to the first and second lens rims, respectively, and
first and second magnets permanently affixed to the frame; and
the auxiliary eyeglasses comprising:
an auxiliary frame, the auxiliary frame comprising an auxiliary bridge, first and second auxiliary lens rims connected by the auxiliary bridge, and first and second arms connected to the first and second auxiliary lens rims, respectively, the first and second arms each having a respective recessed socket, each of the sockets provided with respective metallic, non-magnetized bottom and side walls, the side walls being oriented substantially vertical when the primary eyeglasses are worn on the human face and attached to the auxiliary eyeglasses; and
first and second auxiliary lenses mounted to the first and second auxiliary lens rims, respectively,
wherein the magnets have protruding portions sized and configured to be received in corresponding ones of the sockets and to magnetically attract the metallic, non-magnetized bottom and side walls of the sockets to permit catch-and-click mating engagement of the magnets with the sockets.

11. The eyewear assembly of claim 10, wherein the first and second magnets are attached to the first and second lateral temple mounts, respectively.

12. The eyewear assembly of claim 10, further comprising first and second ear pieces covering distal portions of the first and second temples, respectively.

13. The eyewear assembly of claim 10, wherein the metallic, non-magnetized bottom and side walls define a cup.

14. The eyewear assembly of claim 10, wherein the metallic, non-magnetized side walls have a circular cross section.

15. The eyewear assembly of claim 10, wherein the metallic, non-magnetized bottom and side walls are paramagnetic.

16. The eyewear assembly of claim 10, wherein the metallic, non-magnetized bottom and side walls comprise stainless steel.

17. The eyewear assembly of claim 10, wherein the first and second temples are pivotally connected to the first and second lateral temple mounts.

18. The eyewear assembly of claim 10, wherein when the primary eyeglasses are worn on the human face, the magnets has a longitudinal axis oriented vertically for being received into one of the sockets from above.
